(19) United States
(12) Patent Application Publication
(10) Pub. No.: US 2007/0005759 A1
(43) Pub. Date: Jan. 4, 2007

(54) Passive watchdog method and apparatus

(75) Inventors: Glen D. Schaff, Brookline, MA (US); Eric Louis, N. Chelmsford, MA (US)

Correspondence Address: WILMER CUTLER PICKERING HALE AND DORR LLP, 399 PARK AVENUE, NEW YORK, NY, 10022, US

(73) Assignee: VideogeniX, Brookline, MA (US)

(21) Appl. No.: 11/448,604

(22) Filed: Jun. 7, 2006

Related U.S. Application Data
(63) Continuation-in-part of application No. 10/746,171, filed on Dec. 24, 2003.
(63) Continuation-in-part of application No. 11/386,386, filed on Mar. 22, 2006.
(60) Provisional application No. 60/436,346, filed on Dec. 26, 2002.
(60) Provisional application No. 60/487,486, filed on Jul. 16, 2003.
(60) Provisional application No. 60/487,271, filed on Jul. 16, 2003.
(60) Provisional application No. 60/665,416, filed on Mar. 25, 2005.
(60) Provisional application No. 60/688,668, filed on Jun. 8, 2005.

(51) Int. Cl. G06F 15/173

(52) U.S. Cl. 709/224

(57) ABSTRACT

A method of correcting a lockup error condition of a device includes a watchdog apparatus receiving an indication of activity from the device. The method also includes making a determination, from the indication of activity, whether the device is in a lockup condition. The method also includes interrupting power to the device with the watchdog apparatus if the determination is that the device is in the lockup condition. The watchdog apparatus includes a power input port for receiving power from a power source, a power output port for providing power to the device, and an activity port for receiving an indication of activity from the device. The watchdog apparatus makes a determination, from the indication of activity, whether the device is in a lockup condition, and interrupts the power provided to the device if the determination is that the device is in the lockup condition.

### CROSS REFERENCE TO RELATED APPLICATIONS

This application claims benefit of U.S. Provisional Patent Application Ser. No. 60/688,668, filed Jun. 8, 2005, which is incorporated by reference herein in its entirety.

This application is also a Continuation in Part of U.S. patent application Ser. No. 11/386,386, filed Mar. 22, 2006, which is incorporated by reference herein in its entirety.

This application is also a Continuation in Part of U.S. patent application Ser. No. 10/746,171, filed Dec. 24, 2003, which is incorporated by reference herein in its entirety.

### TECHNICAL FIELD

The present invention relates to electronics systems, and more particularly, to techniques for recovering from lockup conditions that occur from time to time in electronics systems.

### BACKGROUND OF THE INVENTION

Electronics and electro/mechanical systems, in particular digital electronics systems, are pervasive in modern life. We have come to almost unconsciously rely on such systems for communications, education, entertainment, transportation, and surveillance, among other applications.

Many of these electronics systems have an unfortunate aspect in common—they can at times cease to function, i.e., transition to a condition known as “lockup” or “latch-up.” These lockups are typically not a result of a permanent system failure, but instead are a temporary, correctable state of the system.

There are several reasons for the occurrence of lockups. For example, electronics systems with software or firmware code executing on a processor can lock up due to an error (i.e., a “bug”) in the code. For example, the error can cause the processor execution to enter a loop for which there is no exit. Or the error can cause the processor to go to a state for which it is waiting for an input that never comes.

High energy particles can also cause lockups. Such particles can change the state of the electronics system in a way that requires external intervention to correct.

Although the causes of a lockup are varied, sometimes the only way to recover from a lockup is to cycle power to the affected system. Cycling power means to temporarily remove the power source that is supplying electrical energy to the system, then to reapply the power source after some period of time. Cycling power causes the system to shut down, then to restart upon reapplication of power from an initialization point that has been designed into the system.

In some cases, it is inconvenient to cycle power to a system. For example, consider a digital electronics device mounted at the top of a remotely located tower. In order to cycle power to such a device, a worker must be dispatched to the tower location with the proper equipment to access the device (e.g., a ladder or truck-based hydraulic lift system), then physically remove and reapply the power source.

Further, it may not readily apparent whether the device is in a lockup state. When the device is in a remote or generally inaccessible location, monitoring the device for proper operation may not occur frequently, so the device could remain in an undetected lockup state for a significant amount of time.

### SUMMARY OF THE INVENTION

One or more of the embodiments described herein is an electronic device used to detect and correct a hardware circuit malfunction or latch-up. Latch-ups occur regularly on electronic instrumentation including computers, digital cameras, network routers, network switches, network gateways, client bridges, access points, repeaters, among others. (see, for example, E. Normand, “Single Event Upset at Ground Level,” IEEE Transactions on Nuclear Science, vol. 43, pp. 2742-2750, 1996). The operation of the described embodiments can be inline with the input power to the system or device being monitored. The electronic device of the described embodiments may be externally attached as an after-market device, or internally integrated with the system being monitored, for example to or within an enclosure housing the system being monitored.

When the electronic device of the described embodiments detects a discernible latch-up in the circuit or system being monitored, the device will break the power line connection to the monitored device or system in such a manner as to shut the device down. The described device then re-applies power so the device returns to an initial operating state. By encapsulating an entire circuit or system subject to latch-up within the operation of the described embodiments, and then resetting the entire system, the described embodiments perform a full reset and not a limited reset that is typical of many built-in watchdog devices such as those used onboard devices like microprocessors or digital communication chips.

In one aspect, the invention is a method of correcting a lockup error condition of a device. The method includes receiving, by a watchdog apparatus, an indication of activity from the device. The method also includes making a determination, from the indication of activity, whether the device is in a lockup condition. The method further includes interrupting power to the device with the watchdog apparatus if the determination is that the device is in the lockup condition.

In one embodiment, the method further includes interrupting power to the device for a predetermined interval. The predetermined interval is sufficient to cause the device to execute an initialization procedure. In another embodiment the receiving step includes receiving light from the device as an indication of activity. The light may include light emitted from one or more light emitting diodes.

In another embodiment, the receiving step includes intercepting communications signals produced by the device as an indication of activity. The communications signals may include electromagnetic energy transmitted by an antenna associated with the device. In another embodiment, the receiving step includes receiving a heartbeat signal from the device.

In one embodiment, interrupting the power includes reducing the power supplied to the device. In another embodiment, interrupting the power includes modulating the power supplied to the device.

In one embodiment, making a determination includes detecting a variation from normal activity. Another embodiment includes providing a failure indication if interrupting the power to the device does not correct the lockup error condition. The failure indication may be, for example, a buzzer, a light or a transmitted signal.

In another aspect, an apparatus for correcting a lockup error condition of a device includes a power input port for receiving power from a power source, a power output port for providing power to the device, and an activity port for receiving an indication of activity from the device. The apparatus makes a determination, from the indication of activity, whether the device is in a lockup condition, and interrupts the power provided to the device if the determination is that the device is in the lockup condition.

In one embodiment, the apparatus interrupts power to the device for a predetermined interval. The predetermined interval is sufficient to cause the device to execute an initialization procedure.

In one embodiment, the indication of activity includes light from the device. The light may be light emitted from one or more light emitting diodes. In another embodiment, the indication of activity includes communications signals produced by the device. The communications signals may include electromagnetic energy transmitted by an antenna associated with the device. In yet another embodiment, the indication of activity includes a heartbeat signal from the device.

In one embodiment, the apparatus interrupts the power by reducing the power supplied to the device. In another embodiment, the apparatus interrupts the power by modulating the power supplied to the device.

In one embodiment, the apparatus makes the determination of whether the device is in a lockup condition by detecting a variation from normal activity of the device.

In another embodiment, the apparatus further includes a failure indication for indicating when interrupting the power to the device fails to correct the lockup error condition. The failure indication may include, for example, an audible signal such as a buzzer or a tone from a speaker.

### BRIEF DESCRIPTION OF DRAWINGS

FIG. 1 shows a block diagram of one embodiment of a watchdog apparatus.

FIG. 2 shows one embodiment of the watchdog apparatus shown in FIG. 1.

FIG. 3 shows another embodiment of the watchdog apparatus shown in FIG. 1.

### DESCRIPTION OF THE PREFERRED EMBODIMENTS

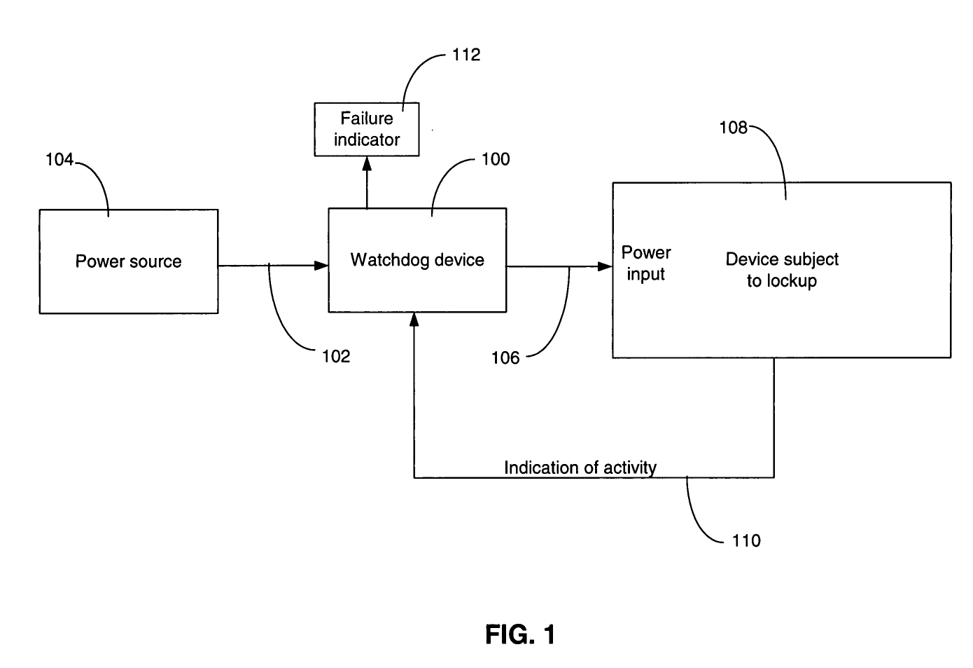

FIG. 1 shows a block diagram of one embodiment of a watchdog apparatus 100 according to the invention. The watchdog apparatus 100 receives input power 102 from a power source 104, and provides a controlled input power 106 to a device subject to lockup 108. The watchdog apparatus 100 also receives an indication of activity 110 from the device 108.

Initially, the watchdog apparatus 100 couples the input power 102 directly to the controlled input power 106 to supply input power to the device 108. Once the device 108 has had sufficient time to initialize and begin operation, the watchdog apparatus 100 monitors the indication of activity 110 from the device 108. The amount of time deemed sufficient for the device 108 to initialize and begin operation is dependent upon the nature of the device 108, and may vary from device to device.

The watchdog apparatus uses the indication of activity 110 to determine whether the device 108 is active. The indication of activity can take many forms. For example, if the device 108 communicates with an external entity, the indication of activity 110 can simply be the presence of communication traffic from the device 108 to the external entity. Another example of an indication of activity 110 could be an indicator provided by the device 108 such as a visual indicator such as a lamp or light emitting diode (LED), or an audio indicator such as a periodic tone, or even a characteristic of the controlled input power 106 to the device. Specific embodiments described here present several examples of the indication of activity 110.

When the watchdog apparatus 100 determines that the indication of activity from the device 108 shows abnormal activity, the watchdog apparatus 100 interrupts power to the device 108 for a predetermined interval. The particular length of the interval depends on the characteristics of the device 108, i.e., how much of an interruption is necessary for the specific device to begin its initialization procedure once power is restored.

In some embodiments, it may not be necessary to interrupt power to the device 108 completely. For example, in some cases a mere reduction of power or a modulation of the input power may be sufficient to cause the device 108 to initialize.

In other embodiments, the watchdog apparatus 100 may include a failure indicator 112 that indicates that the system being monitored is in a failure state for which the watchdog apparatus 100 cannot correct. This failure indicator may be any sort of indication that can draw the attention of a person or entity that can take remedial action. The failure indicator can be an audible indicator, such as a buzzer or speaker, or it can be a visual indicator such as a lamp or LED, or it can be a transmitted signal (wireless or wired), or any other indicator known in the art.

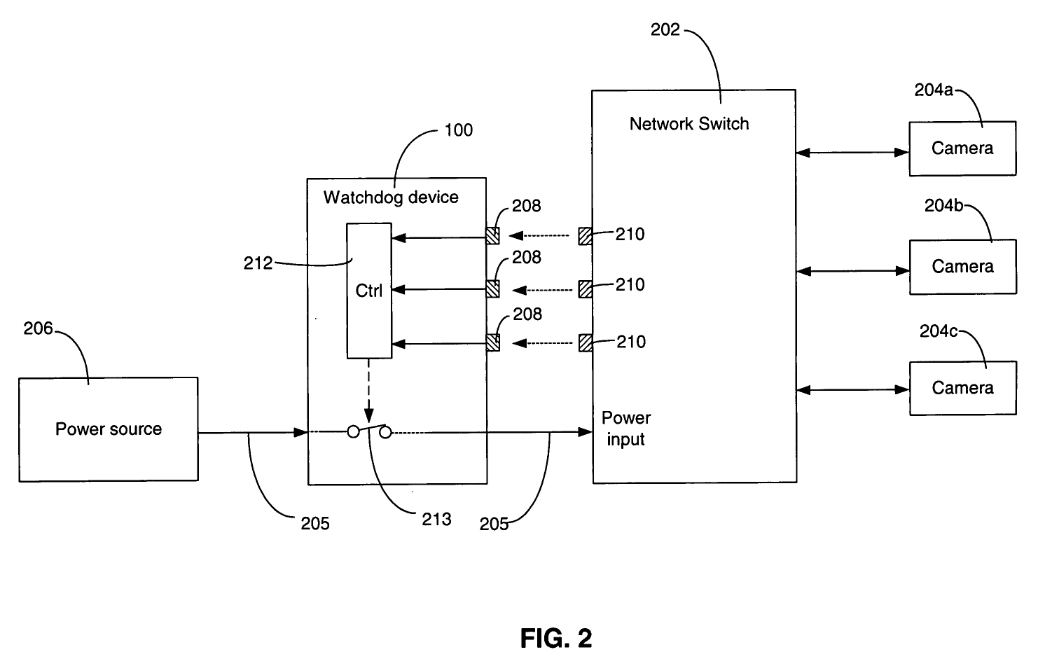

FIG. 2 shows one particular embodiment of the invention. In this embodiment, the watchdog apparatus 100 is associated with a network switch 202 within a system known to have several video cameras 204a, 204b and 204c that continuously stream video and possibly other remote heartbeat applications. A “heartbeat” as used herein is a communication event expected to occur on discernable intervals).

In this instance the watchdog apparatus 100 is wired inline with power 205 from an external source 206 to the network switch 202. In this embodiment, the watchdog apparatus 100 includes a set of photo detectors 208 for monitoring external LEDs 210 on the network switch. The photo detectors 208 are coupled to a controller 212. External LEDs 210 as shown in FIG. 2 are typical to commercially available network switches. Thus, the LEDs 210 provide the indication of activity 110 described for FIG. 1.

In operation, if the controller 212 does not sense activity (through the photo detectors 208) identifying normal network operation for the network switch 202 via the LEDs 210, the watchdog apparatus 100 automatically cuts and restores power, via an interrupter 213, to the network switch 202. In this embodiment, the interrupter 213 is shown as a switch, but in other embodiments the interrupter 213 may be an attenuator or a modulator, or other component known in the art for changing the input power aside from completely cutting it. The interval between cutting and restoring power is long enough so as to force the network switch 202 to reboot, and go through its initial setup configuration procedure. The length of the interval is dependent on the characteristics of the particular network switch.

In the event that the network switch 202 is not expected to generate repeatable activity (i.e., a heartbeat), then an external heartbeat application could be installed to force a detectible pattern in the system so the watchdog apparatus 100 will recognize regular network switch operation. In other embodiments, different types of sensors beyond photo sensors or detectors may be used to monitor proper operation of the system (the network switch 202 in this embodiment). Such sensor may include but are not limited to, thermocouples, radio receivers, digital inputs, serial, SATA, USB, firewire, POE and Ethernet inputs.

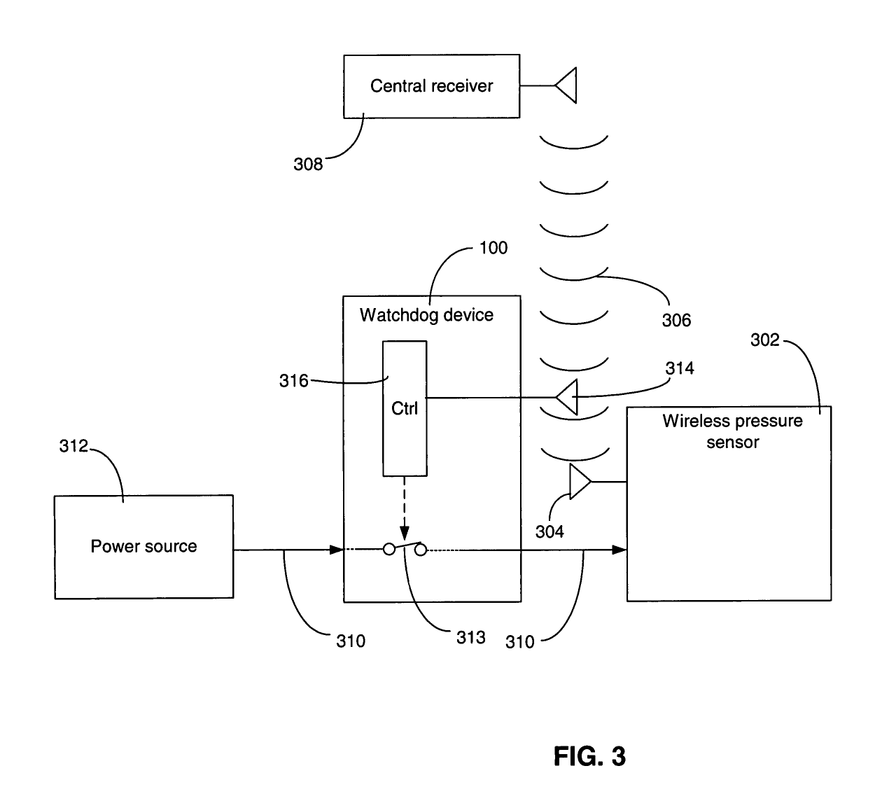

Another embodiment of a watchdog apparatus is shown in FIG. 3. In this embodiment, the watchdog apparatus 100 is associated with to a wireless pressure sensor 302. The wireless pressure sensor 302 is connected to, for example, a pneumatic system (not shown) and measures pressure at some point within the system. The wireless pressure sensor 302 includes an antenna 304 from which the sensor 302 transmits information 306 pertaining to pressure the sensor measures. A central receiver 308 receives the information 306 from the pressure sensor 302.

As with the embodiment of FIG. 2, the watchdog apparatus 100 is wired inline with power 310 from an external source 312 to the wireless pressure sensor 302. In this embodiment, the watchdog apparatus 100 also includes an antenna 314 for intercepting the information 306 in the form of electromagnetic energy transmitted from the pressure sensor 302. The antenna 314 is coupled to a controller 316. The controller 316 interprets the information 306 transmitted from the wireless pressure sensor 302 to determine whether the pressure sensor 302 is operating properly. Thus, the information 306 transmitted from the pressure sensor 302 provides the indication of activity 110 described for FIG. 1.

In operation, if the control device 316 does not sense activity (through the antenna 314) identifying normal operation of the wireless pressure sensor 302 via the transmitted information 306, the watchdog apparatus 100 automatically cuts and restores power, via an interrupter 313, to the wireless pressure sensor 302. Again, as described for the embodiment of FIG. 2, although the interrupter 313 is shown in FIG. 3 as a switch, it can take other forms known in the art for changing the power to the pressure sensor 302. As described for the embodiment described in FIG. 2, the interval between cutting and restoring power is long enough so as to force the wireless pressure sensor to restart and execute its initial setup configuration procedure. The length of the interval is dependent on the characteristics of the particular pressure sensor 302.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method of correcting a lockup error condition of a device, comprising:
receiving, by a watchdog apparatus, an indication of activity from the device;
making a determination, from the indication of activity, whether the device is in a lockup condition; and,
interrupting power to the device with the watchdog apparatus if the determination is that the device is in the lockup condition.

2. The method of claim 1, further including interrupting power to the device for a predetermined interval, wherein the predetermined interval is sufficient to cause the device to execute an initialization procedure.

3. The method of claim 1, wherein the receiving step includes receiving light from the device as an indication of activity.

4. The method of claim 3, wherein the light from the device includes light emitted from one or more light emitting diodes.

5. The method of claim 1, wherein the receiving step includes intercepting communications signals produced by the device as an indication of activity.

6. The method of claim 5, wherein the communications signals include electromagnetic energy transmitted by an antenna associated with the device.

7. The method of claim 1, wherein the receiving step includes receiving a heartbeat signal from the device.

8. The method of claim 1, wherein interrupting the power includes reducing the power supplied to the device.

9. The method of claim 1, wherein interrupting the power includes modulating the power supplied to the device.

10. The method of claim 1, wherein the making a determination step includes detecting a variation from normal activity.

11. The method of claim 1, further including providing a failure indication if interrupting the power to the device does not correct the lockup error condition.

12. The method of claim 11, wherein the failure indication is a buzzer.

13. An apparatus for correcting a lockup error condition of a device, comprising:
a power input port for receiving power from a power source;
a power output port for providing power to the device; and,
an activity port for receiving an indication of activity from the device;
wherein the apparatus makes a determination, from the indication of activity, whether the device is in a lockup condition, and interrupts the power provided to the device if the determination is that the device is in the lockup condition.

14. The apparatus of claim 13, wherein the apparatus interrupts power to the device for a predetermined interval, the predetermined interval being sufficient to cause the device to execute an initialization procedure.

15. The apparatus of claim 13, wherein the indication of activity includes light from the device.

16. The apparatus of claim 15, wherein light from the device includes light emitted from one or more light emitting diodes.

17. The apparatus of claim 13, wherein the indication of activity includes communications signals produced by the device.

18. The apparatus of claim 17, wherein the communications signals include electromagnetic energy transmitted by an antenna associated with the device.

19. The apparatus of claim 13, wherein the indication of activity includes a heartbeat signal from the device.

20. The apparatus of claim 13, wherein the apparatus interrupts the power by reducing the power supplied to the device.

21. The apparatus of claim 13, wherein the apparatus interrupts the power by modulating the power supplied to the device.

22. The apparatus of claim 13, wherein the apparatus makes the determination by detecting a variation from normal activity.

23. The apparatus of claim 13, wherein the apparatus further includes a failure indication for indicating when interrupting the power to the device fails to correct the lockup error condition.

24. The apparatus of claim 23, wherein the failure indication is a buzzer.
